(19) United States
(12) Patent Application Publication
(10) Pub. No.: US 2026/0346193 A1
(43) Pub. Date: Nov. 5, 2026

(54) DEHUMIDIFIER AND MEMBRANE CARTRIDGE THEREFOR

(71) Applicant: Evercloak Inc., Kitchener (CA)

(72) Inventors: Joseph ELKU, Tillsonburg (CA); Kodey VANCE, Port Elgin (CA); Michael FOPPIANO, Kitchener (CA); Bent JORGENSEN, Oakville (CA); Rowayne MURZELLO, Waterloo (CA)

(21) Appl. No.: 19/111,844

(22) PCT Filed: Aug. 30, 2023
(86) PCT No.: PCT/CA2023/051146

§ 371 Date: Mar. 14, 2025

Related U.S. Application Data
(60) Provisional application No. 63/406,426, filed on Sep. 14, 2022.

(51) Int. Cl. B01D 53/26; B01D 53/22; B01D 63/08; B01D 71/02; F24F 1/0358

(52) U.S. Cl. CPC B01D 53/268; B01D 53/227; B01D 63/0822; B01D 71/024; F24F 1/0358; B01D 2053/222; B01D 2257/80; B01D 2313/042; B01D 2313/131; B01D 2313/44; B01D 2313/56

(57) ABSTRACT

A membrane cartridge for a dehumidification apparatus has a cartridge frame having an interior cavity and opposed face openings in fluid communication with the interior cavity. The frame has an edge with edge openings in fluid communication with the interior cavity and face openings. Inserts having perforated surfaces aligned with the face openings are bounded by borders adjacent the face openings. Membranes are attached to the cartridge frame over the inserts and face openings, the membranes sealed with respect to the face openings. A dehumidification apparatus that can employ the membrane cartridge has a housing with openings permitting a gas flow therethrough with the membrane cartridge parallel to the gas flow. A compressible seal is situated between the edge of the frame and the housing and a fastener between the housing and the membrane cartridge is configured to pull the membrane cartridge toward the housing to compress the seal.

### CROSS-REFERENCE TO RELATED APPLICATIONS

This application claims the benefit of U.S. Provisional Patent Application 63/406,426 filed Sep. 14, 2023, the entire contents of which is herein incorporated by reference.

### FIELD

This application relates to dehumidification of a gas stream, in particular to dehumidification apparatuses and membrane cartridges useful in dehumidification apparatuses.

### BACKGROUND

Graphene oxide (GO) membranes are selectively permeable to water, which makes GO membranes attractive for water separation applications, such as in the dehumidification of an air stream. However, the fragility of GO membranes presents challenges in utilizing GO membranes in commercial dehumidification apparatuses.

There remains a need for dehumidifiers and membrane cartridges therefor that can successfully utilize GO membranes for the dehumidification of an air stream.

### SUMMARY

A membrane cartridge for a dehumidification apparatus comprises: a cartridge frame having an interior cavity and having a first face opening and a second face opening in fluid communication with the interior cavity, the cartridge frame further having an edge, the edge comprising one or more edge openings in fluid communication with the interior cavity and the two face openings; a first insert comprising a first perforated surface aligned with the first face opening, the first perforated surface bounded by a first border adjacent the first face opening; a second insert comprising a second perforated surface aligned with the second face opening, the second perforated surface bounded by a second border adjacent the second face opening; a first membrane attached to the cartridge frame over the first insert and the first face opening, the first membrane sealed with respect to the first face opening; and, a second membrane attached to the cartridge frame over the second insert and the second face opening, the second membrane sealed with respect to the second face opening.

A dehumidification apparatus comprises: a housing having openings permitting a flow of a gas therethrough; a membrane cartridge parallel to the flow of gas, the membrane cartridge having an edge adjacent to the housing; a compressible seal between the edge of the membrane cartridge and the housing; and, a fastener between the housing and the membrane cartridge, the fastener configured to pull the membrane cartridge toward the housing to compress the seal.

A dehumidifier system comprises the dehumidification apparatus described above and/or the membrane cartridge described above.

The membrane cartridge comprises a cartridge frame. The cartridge frame may be of any suitable perimetrical shape for which a dehumidifier is adapted. For example, the cartridge frame may be polygonal (e.g., rectangular, square and the like), circular or oval. Many dehumidifiers are adapted for rectangularly-shaped membrane cartridges; thus, the cartridge frame is preferably rectangular. The cartridge frame as a thickness; therefore, perimetrical frame elements of the cartridge frame bound a volume defined by the inside lengths and widths of the frame elements together with the thickness of the frame. The bounded volume is an interior cavity surrounded by the cartridge frame and opposed face openings of the cartridge frame

The cartridge frame comprises an edge comprising one or more edge openings in fluid communication with the interior cavity and the two face openings. The edge openings are through apertures that fluidly connect the interior cavity to an exterior around the membrane cartridge. Fluid (e.g., water vapor and condensed water) that collects in the interior cavity during operation of the membrane cartridge in a dehumidifier drains out of the interior through the one or more edge openings. The edge of the cartridge frame may also comprise one or more locating apertures alignable with corresponding one or more indexing pins on a dehumidifier to properly align the membrane cartridge when the membrane cartridge is mounted in the dehumidifier. In some embodiments, the edge openings and the locating apertures are on the same edge of the cartridge frame.

A semipermeable membrane, for example a graphene oxide membrane, covers each face opening of the cartridge frame thereby enclosing the interior cavity. The membranes are attached and sealed to the cartridge frame. The membrane may be attached to the frame by any suitable method, for example, by adhesives, with clamps, with staples, with screws and the like. The membranes may be sealed to the frame by one or more seals (e.g., gaskets and the like) or by a sealant (e.g., adhesives, caulking and the like. Preferably, the membranes are attached and sealed to the frame by an adhesive. The adhesive is preferably water-insoluble. Epoxy-based adhesives are particularly preferred.

Because the membranes are flexible and somewhat fragile, each of the membranes is supported by a respective insert disposed between the two membranes in the interior cavity and aligned with the face openings. The inserts have perforated surfaces to permit fluid (e.g., water vapor and condensed water) that passes through the membrane from outside the interior cavity to pass into the interior cavity. The inserts have perimetrical borders that are disposed adjacent the face openings. The borders of the inserts are perimetrical portions that are substantially free of protrusions such as the perforations, pins and posts that adorn most of the interior-facing surfaces of the inserts. The inserts may be attached to one another in the interior cavity, attached to the cartridge frame, attached to both the cartridge frame and one another, or not attached to anything but held in place by the membranes.

The inserts may be attached to one another in one or more ways, for example the inserts may be glued together, screwed together, clamped together or some combination thereof. In some embodiments, the inserts are clamped together. In some embodiments, clamping may be achieved using a snap-lock mechanism. In some embodiments, the snap-lock mechanism comprises a plurality of pins extending into the interior cavity from the perforated surface of one or both of the inserts and a corresponding plurality of receiving apertures on one or both of the opposed inserts, whereby the plurality of pins are inserted and secured within the receiving apertures. The pins may extend from one of the inserts into receiving apertures on the other insert, or both inserts may have pins and receiving apertures corresponding to receiving apertures and pins on the other insert. In some embodiments, the receiving apertures may be formed into a plurality of posts extending from the perforated surface of one or both of the inserts into the interior cavity. The pins may be equipped with heads that are sized and shaped to be pushed into the receiving apertures, the receiving apertures sized and shaped to permit insertion of the pins while preventing or inhibiting withdrawal of the pin once the pin has been inserted.

The inserts may be unattached to the cartridge frame or attached to the cartridge frame in one or more ways, for example with an adhesive, screws, nails, rivets, clamps or some combination thereof. Further, the cartridge frame may be configured to engage with the inserts in one or more different ways. In some embodiments, the cartridge frame comprises one or more recesses with which the border of one or both inserts are engaged. The cartridge frame may comprise a recess adjacent one or both of the face openings. In some embodiments, a recess perimetrical engages with the border of one of the inserts. In some embodiments, one or both the membranes can be provided with a membrane frame that is attached to the cartridge frame. The membrane frame may have an outer lip that contains the insert when the insert is rested on a frame element of the cartridge frame. Thus, the border may sit flush on the cartridge frame without the need for a recess in the cartridge frame whilst still being retained under the membrane over the face opening.

The membrane cartridge permits utilizing graphene oxide (GO) membranes in the dehumidification apparatus for separating water vapor from a gas (e.g., air) stream. In some embodiments, one or both of the membranes may be graphene oxide.

The dehumidification apparatus comprises a housing. The housing may comprise various walls including, for example, a vacuum plate, side plates, a guide plate and a cover. The housing preferably has openings, preferably opposed openings, through which a gas (e.g., humid air) is directed during operation of the apparatus. At least one membrane cartridge, preferably a plurality of membrane cartridges, is disposed in the housing so that the gas flows past the surfaces of the membranes, that is, the membrane cartridge is parallel to the flow of gas. The plurality of membrane cartridges is preferably organized in a cartridge assembly in which the membrane cartridges are disposed parallel to each other with gas flow channels between the membrane cartridges. The gas flow channels preferably have the same width and profile for consistent permeation of water vapor into the membrane cartridges across the cartridge assembly. Air flow through the housing past the membrane cartridge may be accomplished using any suitable device, for example fans, that may be mounted on the apparatus or as part of a larger dehumidification system.

Water vapor and any condensed water collected in the interior of the membrane cartridge can be drained through one or more edge openings in the membrane cartridge. To assist with draining, the apparatus preferably comprises a vacuum system in fluid communication with the interior of the membrane cartridge. In some embodiments, the vacuum system comprises a vacuum chamber, for example a vacuum manifold, in fluid communication with the edge of the membrane cartridge, in particular with one or more edge openings of the membrane cartridge, the one or more edge openings providing through apertures that fluidly connect the interior of the membrane cartridge to the vacuum chamber.

The vacuum plate, which forms part of the housing, preferably a bottom of the housing, may act as an interface between the vacuum chamber and the membrane cartridge. The membrane cartridge is preferably mounted on the housing, preferably the vacuum plate, so that the edge of the membrane cartridge is adjacent to the housing, in particular the vacuum plate. In some embodiments, the vacuum plate comprises one or more vacuum channels that are aligned with the edge openings of the membrane cartridge, thereby providing both a support for the membrane cartridge and a fluid connection to the vacuum chamber. Air tight fluid seals may be provided between the vacuum chamber and the vacuum plate and between the vacuum plate and the edge of the membrane cartridge. Especially the seal between the vacuum plate and the edge of the membrane cartridge is compressible so that pulling the membrane cartridge toward the housing, preferably vacuum plate, compresses the seal to provide better sealing. One or more fasteners, e.g., bolts, clamps and the like, between the membrane cartridge and the housing can be used to pull the membrane cartridge toward the housing to compress the seal. In some embodiments, the one or more fasteners is located in the vacuum chamber.

In order to properly mount and situate the membrane cartridge on its edge in the housing, the housing preferably comprises one or more indexing pins. The one or more indexing pins engage a locating aperture in the edge of the membrane cartridge. When the apparatus comprises a plurality of membrane cartridges, the housing comprises a plurality of indexing pins to help situate the membrane cartridges parallel to each other in a stack of cartridges in the apparatus. The indexing pins are preferably located on an upper surface of the vacuum plate. In some embodiments, a guide plate located at an opposite edge of the membrane cartridge from the edge openings is utilized to assist with proper placement of the membrane cartridge. Further, when a plurality of membrane cartridges is utilized, the apparatus may comprise a cartridge spacer to properly space the membrane cartridges so that the membrane cartridges are parallel to each other and spaced apart desirably.

In some embodiments, one or more of the membrane cartridges is the membrane cartridge as defined above. The edge of the membrane cartridge is the edge of the cartridge frame comprising the one or more edge openings.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A depicts an exploded view of a first embodiment of a membrane cartridge.

FIG. 1B depicts a perspective view of the membrane cartridge of FIG. 1A.

FIG. 1C depicts a cross-section of the membrane cartridge of FIG. 1B.

FIG. 1D depicts an edge view of the membrane cartridge of FIG. 1B.

FIG. 1E depicts a cross-section view through A-A of the membrane cartridge of FIG. 1D.

FIG. 2A depicts an exploded view of a second embodiment of a membrane cartridge.

FIG. 2B depicts a perspective view of the membrane cartridge of FIG. 2A.

FIG. 3A depicts an exploded view of a third embodiment of a membrane cartridge.

FIG. 3B depicts a perspective view of the membrane cartridge of FIG. 3A.

FIG. 4A depicts an exploded view of a dehumidifier.

FIG. 4B depicts a first perspective view of the dehumidifier of FIG. 4A.

FIG. 4C depicts a bottom view of the dehumidifier of FIG. 4B.

FIG. 4D depicts a cross-section view through B-B of the dehumidifier of FIG. 4C.

FIG. 4E depicts a second perspective view of the dehumidifier of FIG. 4A.

FIG. 4F depicts a side cross-section view of the dehumidifier of FIG. 4E.

FIG. 5A depicts an exploded view of a dehumidifier system of FIG. 5A utilizing a dehumidifier of the present invention.

FIG. 5B depicts a schematic diagram of sensor placements in the dehumidifier system of FIG. 5A using a membrane cartridge module containing 3 membrane cartridges of the present invention for a total of 6 membranes.

FIG. 6A depicts a graph of integrated energy factor (IEF, L/kWh) against different inlet conditions (relative humidity (RH, %) and temperature (T, °C)) and flow rates (CFM), summarizing performance results for the dehumidifier system of FIG. 5B.

FIG. 6B depicts a graph showing the relative humidity and temperature at different flow rates in a high moisture environment for the dehumidifier system of FIG. 5B.

FIG. 6C depicts a graph showing the relative humidity and temperature at different flow rates in a low moisture environment for the dehumidifier system of FIG. 5B.

FIG. 7A depicts a graph of integrated energy factor (L/kWh) and humidity ratio (GPP) vs. inlet temperature (°C) at various temperatures between 20 °C and 52 °C summarizing dehumidification performance at a flow rate of 250 CFM for a dehumidifier system of FIG. 5A comprising two membrane cartridge modules containing 15 membrane cartridges each of the present invention for a total of 30 membranes per module.

FIG. 7B depicts a graph of integrated energy factor (L/kWh) against inlet humidity ratio (GPP) at a constant temperature of 20 °C showing dehumidification performance at a flow rate of 250 CFM for the same a dehumidifier system that produced the results in FIG. 7A.

FIG. 7C depicts a graph of integrated energy factor (L/kWh) and humidity ratio (GPP) vs. inlet temperature (°C) at various temperatures between 20 °C and 43 °C summarizing dehumidification performance at a flow rate of 250 CFM for the same a dehumidifier system that produced the results in FIG. 7A.

FIG. 7D depicts a graph of integrated energy factor (L/kWh) against inlet humidity ratio (GPP) vs. flow rate (CFM) at a constant temperature of 30 °C showing dehumidification performance for the same a dehumidifier system that produced the results in FIG. 7A.

FIG. 7E depicts a graph of differential pressure (D/F, Pa) vs. total flow rate (CFM) showing how the differential pressure across the membrane cartridge module increases with an increase in flow rate for the same a dehumidifier system that produced the results in FIG. 7A.

### DETAILED DESCRIPTION

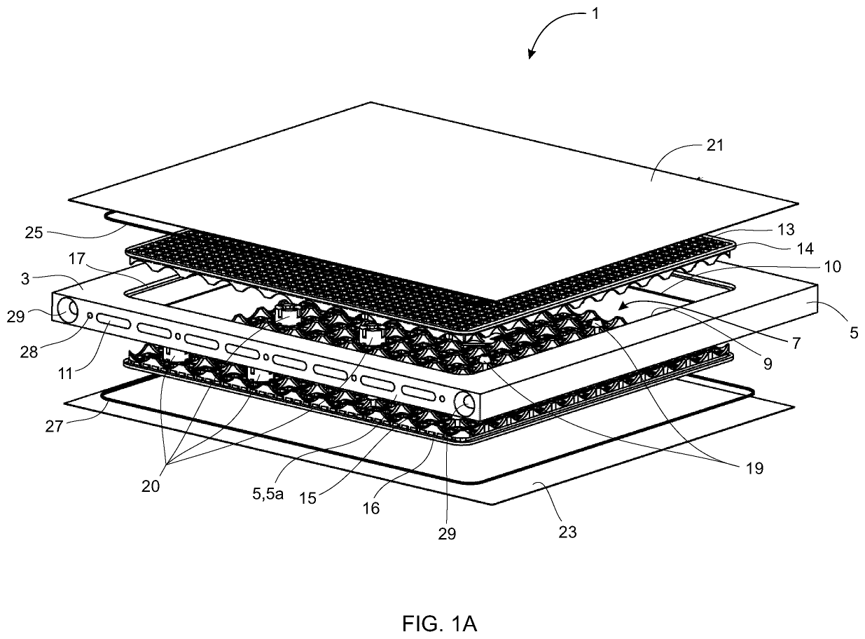

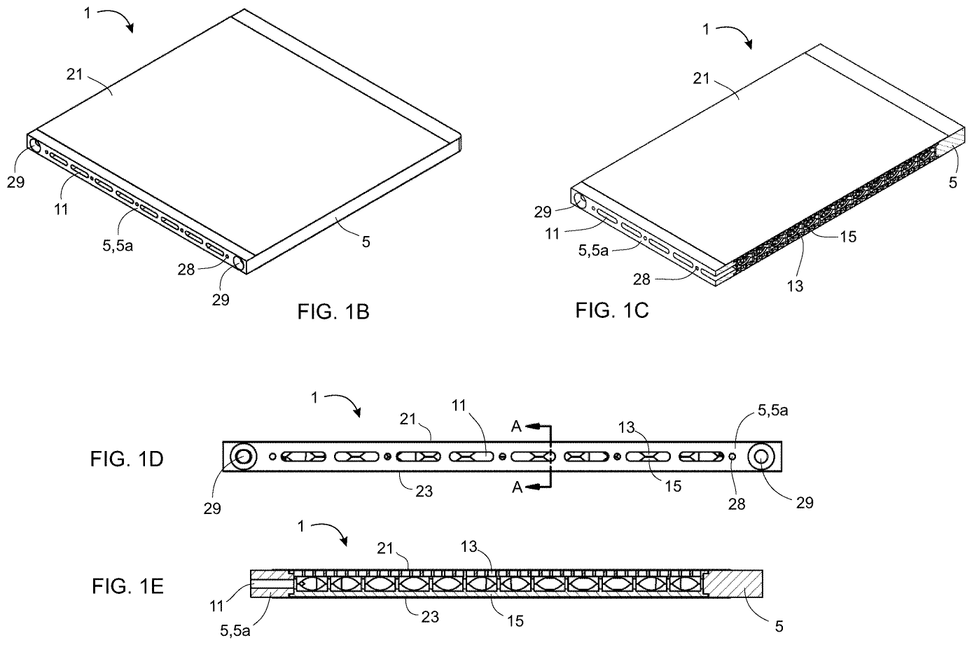

With reference to FIG. 1A to FIG. 1E, a first embodiment of a membrane cartridge 1 comprises a rectangular cartridge frame 3 having four edges 5 (only two labeled) defining an interior cavity 7, the cartridge frame 3 having opposed face openings 9, 10 into the interior cavity 7. One of the edges 5, specifically labeled as 5a, of the cartridge frame 3 comprises a plurality of edge openings 11 (only one labeled) in fluid communication with the interior cavity 7 and the opposed face openings 9, 10. The edge openings 11 are formed through the cartridge frame 3 between outer and inner edge portions of the edge 5a so that fluid, for example water vapor or liquid, that collects in the interior cavity 7 during use of the membrane cartridge 1 can be removed from the interior cavity 7. The membrane cartridge 1 comprises opposed perforated rectangular inserts 13, 15 in the form of rectangular plates having perimetrical borders 14, 16 and a plurality of perforations, the insert 13 aligned with the face opening 9 on one face of the cartridge frame 3 and the insert 15 aligned the face opening 10 on an opposed face of the cartridge frame 3.

The cartridge frame 3 comprises perimetrical recesses 17 in the inner edge portions of the edges 5, one of the recesses 17 surrounding the face opening 9 and another of the recesses (not shown) surrounding the face opening 10. The borders 14, 16 of the inserts 13, 15 engage with respective recesses 17 in the edges 5 of the cartridge frame 3 adjacent to respective face openings 9, 10. The inserts 13, 15 thus cover the face openings 9, 10, respectively, to bound the interior cavity 7 between the edges 5 and between the inserts 13, 15. The recesses 17 have depths that permit the inserts 13, 15 to be fitted in the cartridge frame 3 so that outer surfaces of the inserts 13, 15 are flush with facing surfaces of the cartridge frame 3. Each of the inserts 13, 15 comprise a plurality of locking pins 19 extending into the interior cavity 7 and a plurality of posts 20 comprising receiving apertures also extending into the interior cavity 7. The locking pins 19 of the insert 13 are aligned with the posts 20 of the insert 15 and the locking pins 19 of the insert 15 are aligned with the posts 20 of the insert 13 so that the locking pins 19 can be inserted into the receiving apertures of the posts 20 to secure the two inserts 13, 15 together in a snap-fit manner, thereby securing the cartridge frame 3 between the inserts 13, 15 without directly attaching the borders 14, 16 of the inserts 13, 15 to the cartridge frame 3.

The membrane cartridge 1 further comprises opposed rectangular graphene oxide semipermeable membranes 21, 23 that are supported on and cover the inserts 13, 15, respectively. The membranes 21, 23 are attached to and sealed with the edges 5 of the cartridge frame 3 by annular beads of an epoxy-cyanoacrylate adhesive 25, 27 (e.g., Loctite™ 4090). The membrane cartridge 1 further comprises two locating apertures 29 in the same edge 5a as the edge openings 11, the locating apertures 29 alignable with corresponding one or more indexing pins on a dehumidifier to properly align the membrane cartridge 1 when the membrane cartridge 1 is mounted in a dehumidifier. The membrane cartridge 1 further comprises a plurality of fastener receivers 28 (only one labeled), e.g., bolt holes, in the same edge 5a as the edge openings 11, the fastener receivers 28 configured to engage with fasteners (e.g., bolts) to secure the membrane cartridge 1 to the dehumidifier.

In use in a dehumidifier, as a humid gas stream (e.g., humid air) passes by the graphene oxide semipermeable membranes 21, 23, at least some of the water vapor in the gas stream passes through the membranes 21, 23 and then through the perforations in the inserts 13, 15 into the interior cavity 7, thereby dehumidifying the gas stream. Water vapor and condensed liquid water can be drained through the edge openings 11 in the cartridge frame 3 to prevent accumulation of water in the membrane cartridge 1.

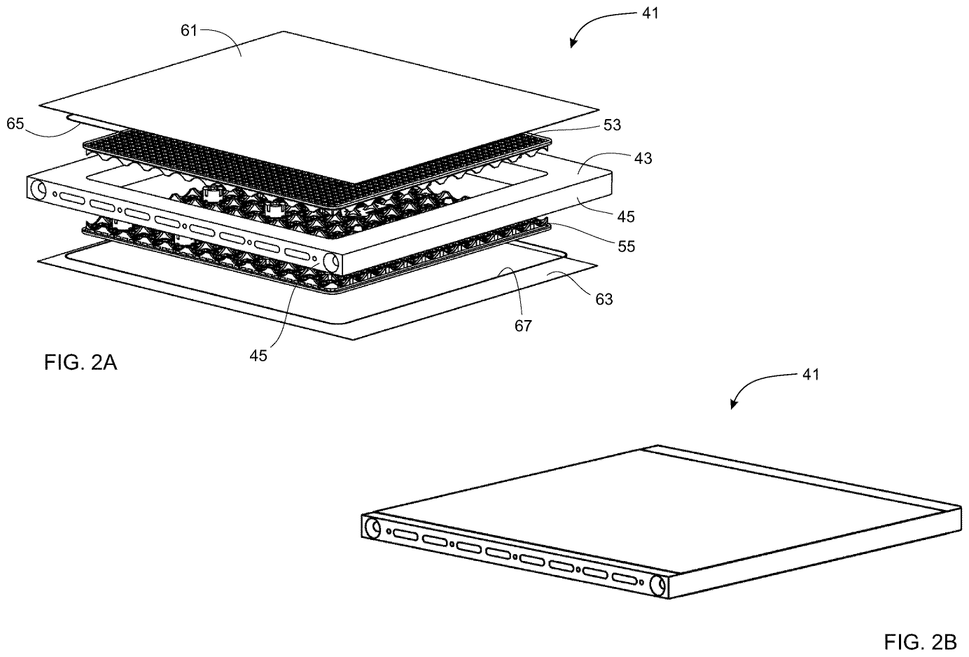

With reference to FIG. 2A and FIG. 2B, a second embodiment of a membrane cartridge 41 is similar to the membrane cartridge 1, having a rectangular cartridge frame 43, rectangular perforated inserts 53, 55 and graphene oxide semipermeable membranes 61, 63 whereby the membranes 61, 63 are supported on the inserts 53, 55, the inserts 53, 55 being connected together in the same manner is in the membrane cartridge 1. The membrane cartridge 41 differs from the membrane cartridge 1 in that the cartridge frame 45 does not have recesses. Instead, the inserts 53, 55 float freely together within the inner edge portions of edges 45 of the cartridge frame 43 and the membranes 61, 63 are attached to and sealed with the cartridge frame 43 by annular beads of an adhesive 65, 67 to hold the inserts 53, 55 in place within the cartridge frame 43. As seen by comparing FIG. 2B to FIG. 1B, the fully assembled membrane cartridge 41 looks the same on the outside as the fully assembled membrane cartridge 1.

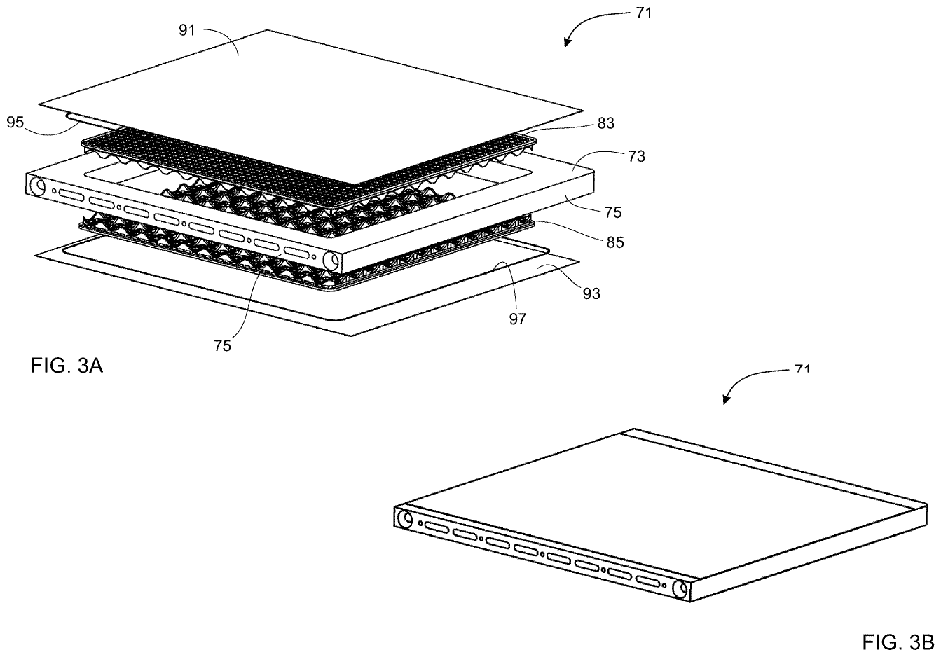

With reference to FIG. 3A and FIG. 3B, a third embodiment of a membrane cartridge 71 is similar to the membrane cartridge 41, having a rectangular cartridge frame 73, rectangular perforated inserts 83, 85 and graphene oxide semipermeable membranes 91, 93 whereby the membranes 91, 93 are supported on the inserts 83, 85. The membrane cartridge 71 differs from the membrane cartridge 41 in that the inserts 83, 85 are not connected together by pins and posts with receiving apertures. Instead, the inserts 83, 85 are glued together. The inserts 83, 85 still float freely together within the inner edge portions of edges 75 of the cartridge frame 73 and the membranes 91, 93 are attached to and sealed with the cartridge frame 73 by annular beads of an adhesive 95, 97 to hold the inserts 83, 85 in place within the cartridge frame 73. As seen by comparing FIG. 3B to FIG. 1B, the fully assembled membrane cartridge 71 looks the same on the outside as the fully assembled membrane cartridge 1.

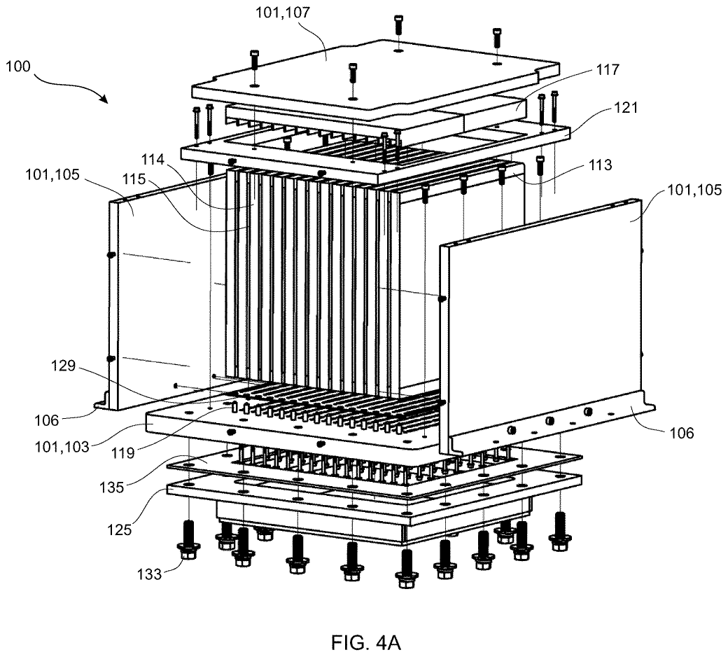

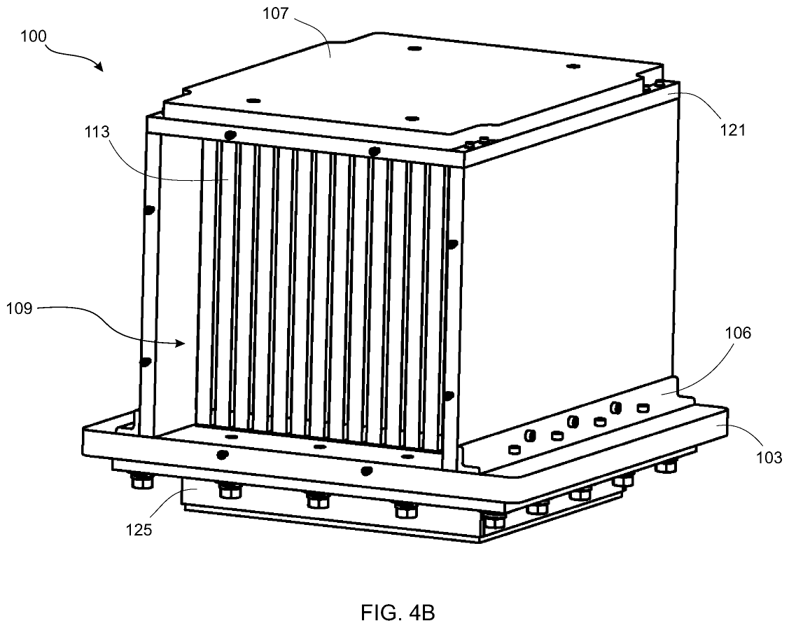

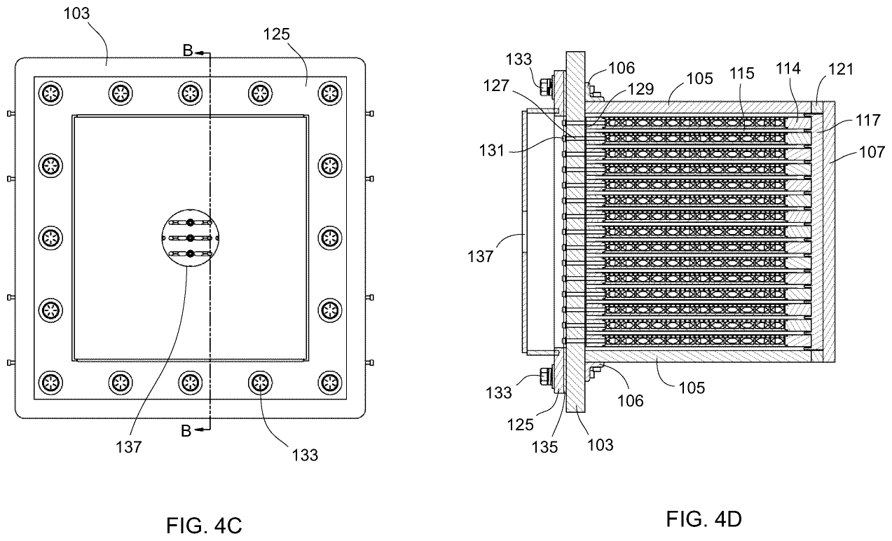

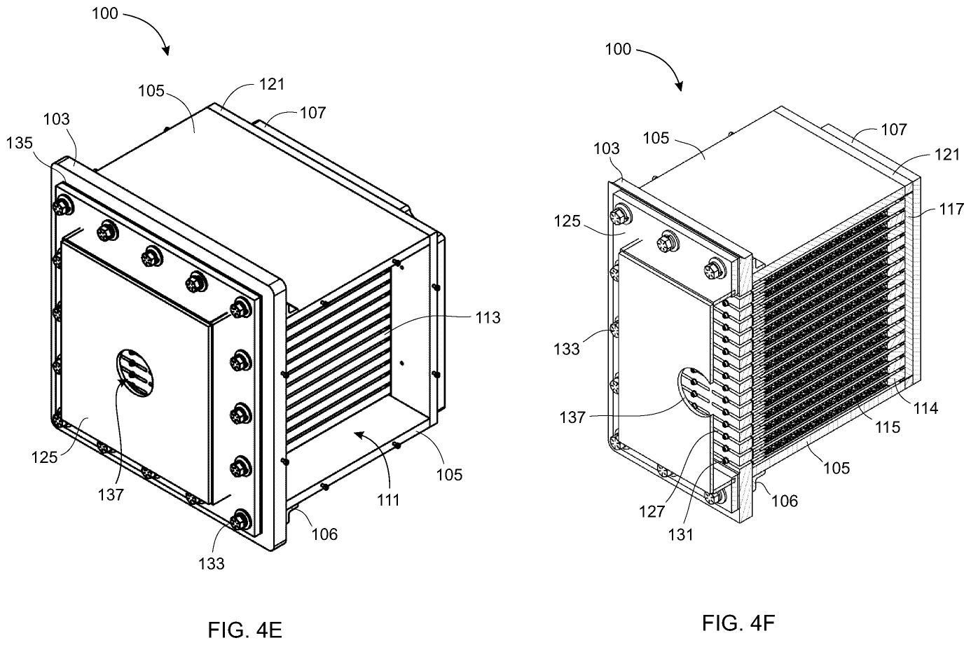

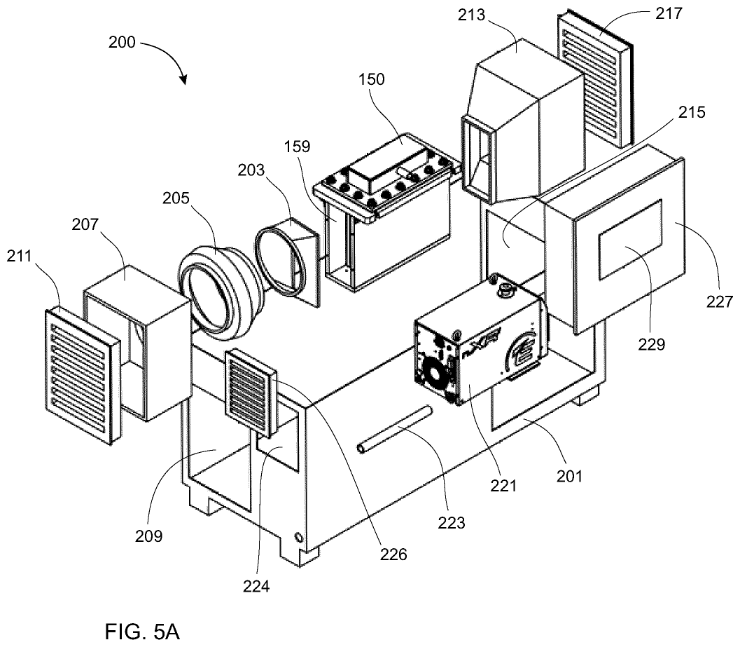

With reference to FIG. 4A to FIG. 4F, a dehumidification apparatus 100 capable of utilizing the membrane cartridges 1, 41 and 71 is depicted. The apparatus 100 comprises a housing 101, the housing 101 comprising a vacuum plate 103 at a bottom of the housing 101, a pair of opposed side plates 105 attached to and extending upwardly from the vacuum plate 103, a guide plate 121 to which the side plates 105 are connected at a top of the housing 101, and a cover 107 connected to a top of the guide plate 121. The side plates 105 are attached to the vacuum plate 103 by angle brackets 106. The housing 101 has opposed front and rear openings 109 and 111, respectively, permitting a flow of a gas through the housing 101.

The apparatus 100 further comprises a cartridge assembly 113 mounted on the vacuum plate 103, the cartridge assembly 113 comprising a plurality of spaced-apart parallel membrane cartridges 114 (only one labeled) arranged so that there is a plurality of parallel gas-flow channels 115 between faces of the membrane cartridges 114. The membrane cartridges 114 and the gas-flow channels 115 are aligned so that the membrane cartridges 114 are parallel to the flow of gas between the front and rear openings 109 and 111, the gas flowing in the gas-flow channels 115 through the housing 101 between the faces of the membrane cartridges 114. Edges of the membrane cartridges 114 are adjacent to the housing 101 with lower edges adjacent the vacuum plate 103 and upper edges adjacent a cartridge spacer 117. The lower edges of the membrane cartridges 114 comprise locating apertures, which can be aligned with and inserted over front and rear indexing pins 119 (only one labeled), the indexing pins 119 formed in front and rear rows and spaced apart in the rows to properly and align and position the membrane cartridges 114 when the membrane cartridges 114 are mounted in the housing 101. The cartridge spacer 117 comprises a series of channels in which upper edges of the membrane cartridges 114 are seated to further help align, position, and secure the membrane cartridges 114 in the housing 101. Furthermore, the guide plate 121 comprises a single large aperture therein, the guide plate 121 situated at a top of the cartridge assembly 113 to help guide individual membrane cartridges 114 into place when being mounted in the housing 101.

The vacuum plate 103 comprises a series of vacuum channels 127 aligned with the edges of the membrane cartridges 114. The vacuum channels 127 are in fluid communication with edge openings in the edges of the membrane cartridges 114, the edge openings in fluid communication with respective interior cavities of the membrane cartridges 114, as described above in connection with the membrane cartridge 1. A first compressible air-tight seal 129 (e.g., an elastomeric gasket) is situated between the edges of the membrane cartridges 114 and the vacuum plate 103. A plurality of fasteners 131 (only one labeled), e.g., bolts, inserted through the vacuum channels 127 are aligned with fastener receivers, e.g., bolt holes, in the edges of the membrane cartridges 114, whereby engagements of the fasteners 131 with the fastener receivers are configured to pull the membrane cartridges 114 toward the vacuum plate 103, and therefore the housing 100, to compress the seal. The apparatus 100 also comprises a vacuum manifold 125 situated below the vacuum plate 103 and secured to the vacuum plate 103 with further fasteners 133 (only one labeled), e.g., bolts. A second compressible air-tight seal 135 (e.g., an elastomeric gasket) is situated between the vacuum manifold 125 and the vacuum plate 103. The vacuum manifold 125 comprises a port 137 connectable to a vacuum system to apply vacuum to the vacuum manifold 125, which is ultimately in fluid communication with the interior cavities of the membrane cartridges 114.

In operation, humid gas (e.g., humid air) flowing through the dehumidification apparatus 100 between the front and rear openings 109 and 111 flows through the gas-flow channels 115 between the membrane cartridges 114. Water vapor in the gas selectively passes through the selectively permeable membranes (e.g., graphene oxide membranes) into the interior cavities of the membrane cartridges 114. Water in the interior cavities of the membrane cartridges 114 rains through the edge openings with assistance of the applied vacuum in the vacuum manifold 125, which is ultimately in fluid communication with the interior cavities of the membrane cartridges 114. Thus, the gas exiting the apparatus 100 is drier in comparison to the humid gas entering the apparatus 100.

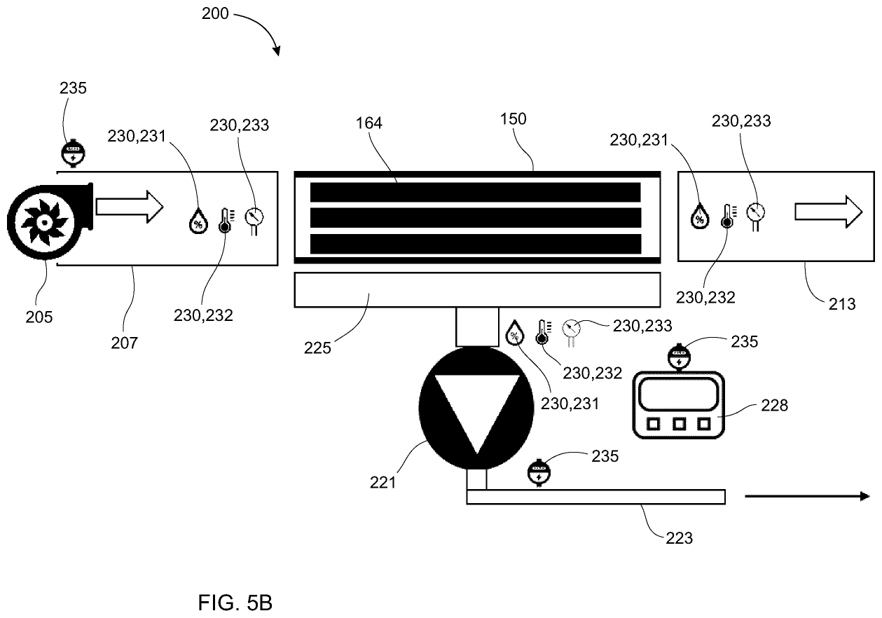

With reference to FIG. 5A and FIG. 5B, a dehumidifier system 200 is shown comprising a dehumidification apparatus 150 of the present invention. The dehumidification apparatus 150 is shown with a width that can accommodate three membrane cartridges (with 6 membranes in total) but the dehumidification apparatus 150 can be wider when more membrane cartridges are desired. The system 200 comprises an enclosure 201 in which the dehumidification apparatus 150 is mounted. Over a front opening 159 of the dehumidification apparatus 150 is mounted an inlet adapter 203 to permit fluid communication between the front opening 159 of the dehumidification apparatus 150 and a blower fan 205, which draws humid air through an inlet duct 207 in which the fan 205 is mounted to deliver the humid air through the inlet adapter 203 into the dehumidification apparatus 150. The inlet duct 207 also mounted in the enclosure 201 and is in fluid communication with an external environment through an open front window 209 in a front wall of the enclosure 201, the front window 209 being covered by an inlet filter 211 that filters out particulate matter from a humid inlet air stream. Over a rear opening 161 of the dehumidification apparatus 150 is mounted an outlet duct 213 to permit fluid communication between the rear opening 161 of the dehumidification apparatus 150 and the external environment through an open rear window 215 in a rear wall of the enclosure 201. A drier outlet air stream from the dehumidification apparatus 150 passes out through the open rear window 215, the open rear window 215 being covered by an outlet filter 217 that prevents particulate matter from infiltrating into the dehumidification apparatus 150 through the outlet duct 213.

A bottom of the dehumidification apparatus 150 is in fluid communication through a vacuum manifold 225 (see FIG. 5B) with a vacuum pump 221, which helps pump water vapor out of the dehumidification apparatus 150 in manner like that described above. Water vapor and pump heat are expelled through an exhaust outlet 223 connected to the vacuum pump 221. The exhaust outlet 223 may be connected to a drain. The enclosure 201 also comprises an air port 224 in a wall of the enclosure 201 to permit equalizing air pressure in the enclosure 201 with air pressure in the external environment. The air port 224 is covered by an air-port filter 226 to help prevent particulate matter from entering the enclosure 201. The dehumidifier system 200 also comprises an electrical cabinet 227 containing electronic controls 228 for the dehumidifier system 200, including a programmable logic controller (PLC). and a display 229 on which system parameters can be displayed.

FIG. 5B is a schematic diagram of the dehumidifier system 200 having a module 164 containing three membrane cartridges in the dehumidification apparatus 150 and showing placements of various sensors 230 including humidity sensors 231, temperature sensors 232 and differential pressure sensors 233. The fan 205, the vacuum pump 221 and the electronic controls 228 all receive electrical power through power meters 235 for their respective operation.

### Example 1

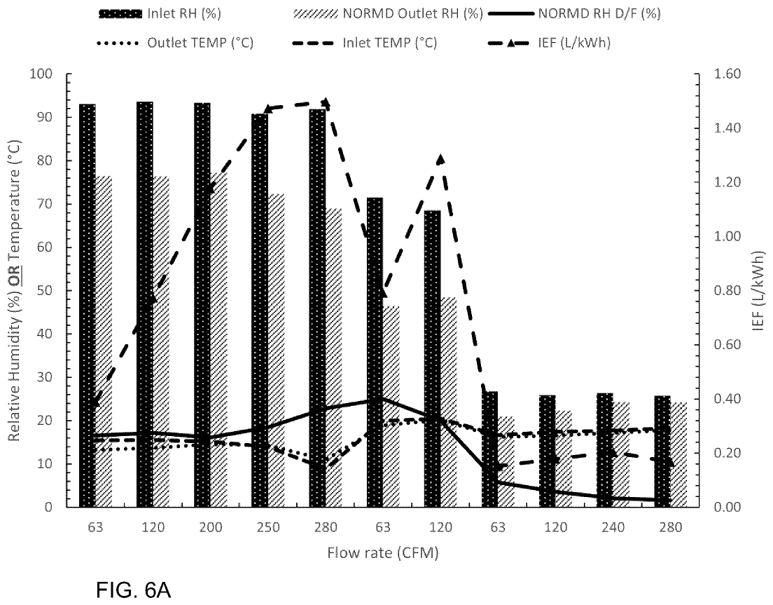

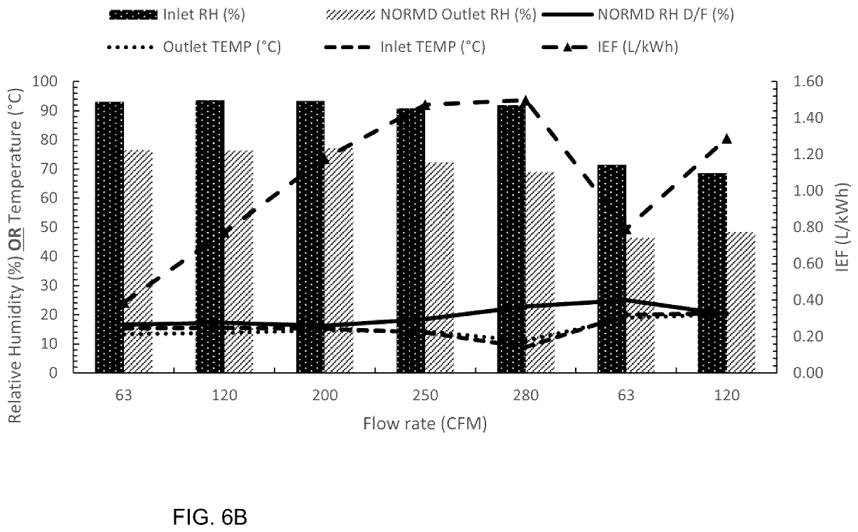

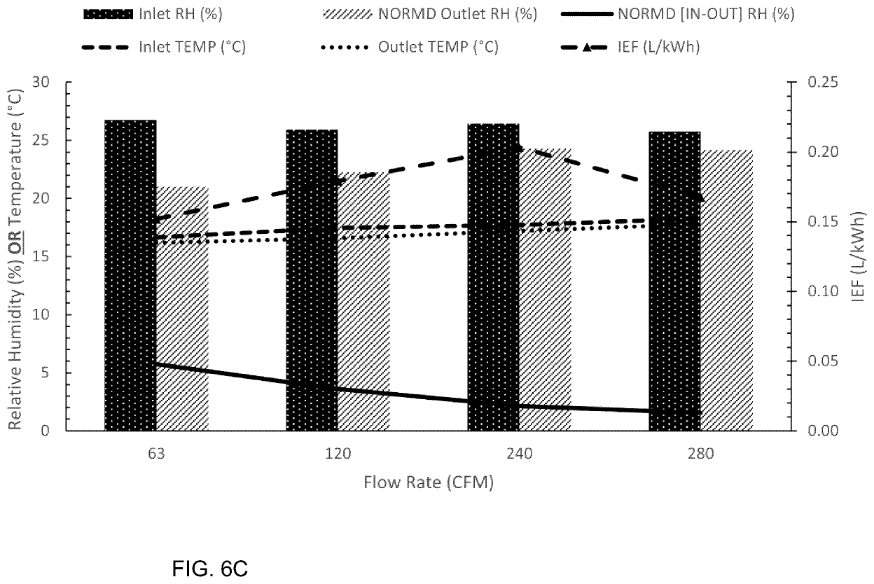

In one experiment, two dehumidifier systems 200 were built, each having three membrane cartridges and a rated air flow rate of 63 CFM. The two systems each had a PLC that could record data every 30 seconds and hold up to a month of data. Each system was connected to the internet so that the user could monitor the systems in real time. After commissioning the systems at a test site, an external humidifier was brought in to simulate higher humidity conditions to ensure that the systems work as expected due to the ambient conditions having been quite dry. Both systems were left to operate continuously and in dehumidification mode for an indefinite period to collect longevity data. FIG. 6A to FIG. 6C show the results.

FIG. 6A summarizes the results. As the flow rate increases, the dehumidifier system can process larger amounts of air and water vapor, which significantly improves the energy efficiency of the system. At higher relative humidity and inlet temperatures, the dehumidifier system performs the best and can exceed the performance of conventional dehumidifiers.

FIG. 6B provides a plot with the artificially generated higher humidity in which the range of relative humidity levels is from 70% to 90% with a temperature range of from 10 °C to 20 °C. At these conditions the dehumidification system was able to reduce the relative humidity by 15% to 25% depending on the ambient humidity and temperature during testing. The system performs better at higher temperatures and higher relative humidity conditions. However, at a flow rate of 280 CFM the normalized relative humidity (RH) difference is higher, which may be an anomaly considering that the humidity ratio is much lower than at the higher temperatures.

Another set of tests, the results of which are shown in FIG. 6C, involved a real-world scenario where the humidifier was shut down and the dehumidifier unit was exposed to a dry environment to evaluate the system's moisture removal capabilities. At the time of testing the relative humidity was averaging 26%, which is considered quite low. However, the dehumidifier systems were still able to reduce the relative humidity by 5% at an inlet temperature of 16 °C. Another test was carried out by carefully evaluating the humidity removal performance at different flow rates. The flow rates were increased by two to four times the design flow rate of 63 CFM and a decrease in relative humidity removal was observed.

### Example 2

In another experiment, the performance of two dehumidifier systems 200 were studied at various flow rates, temperatures and humidity levels. The dehumidifier systems comprised: cartridge modules with 30 membranes per cartridge module rated at 125 CFM; a 375 m³/hr vacuum pump system that comprised a roots booster and a vacuum pump; and, a vacuum pump PLC with variable-frequency drive (VFD) controls for the roots booster. Experiments were conducted in a test chamber having the following: two air heaters; two humidifiers; one large blower fan box; two Accuvalve™ dampers at the inlet; pressure, temperature and humidity sensors located before and after the cartridge modules and in the vacuum line.

The test chamber allows the user to independently control the inlet conditions for each channel and cartridge module. However, for all the tests conducted the inlet conditions for both channels were kept the same to ensure consistency between both cartridge modules. Different inlet conditions for the cartridge modules can result in an unbalanced vacuum level for each cartridge module that can affect the overall power efficiency for a given set of inlet conditions.

All tests were carried out in the following order:

Start the blower fan, turn on the heater and increase the humidity.

Gather data at different humidity levels at a fixed flow rate.

Increase the temperature and vary the humidity levels while maintaining the flow rate.

Repeat the above until the desired temperature is reached while recording moisture removal and energy efficiency.

Choose specific temperature and humidity levels and vary the flow rate to evaluate moisture removal performance.

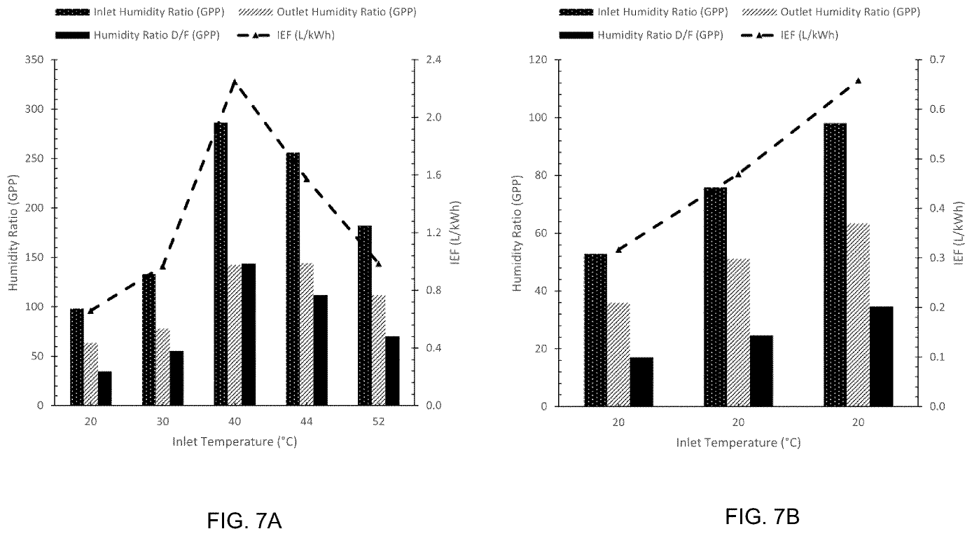

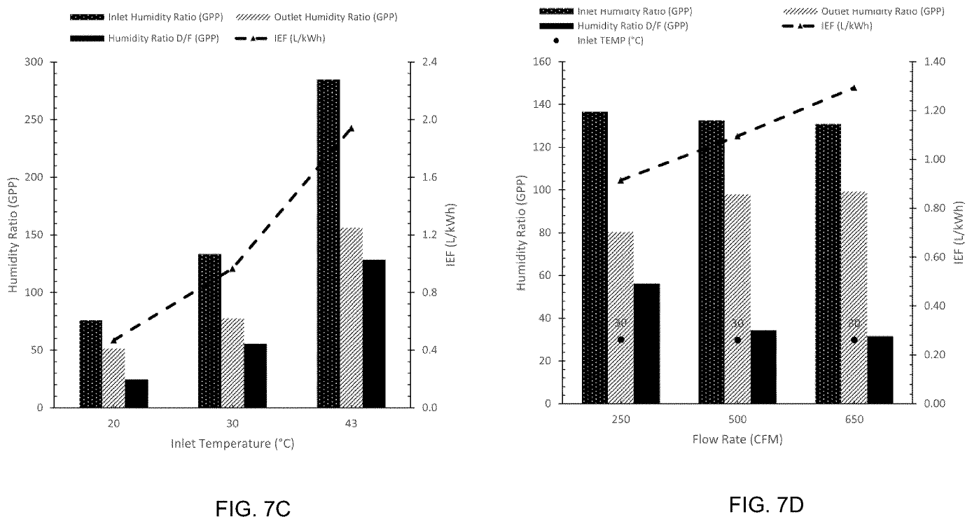

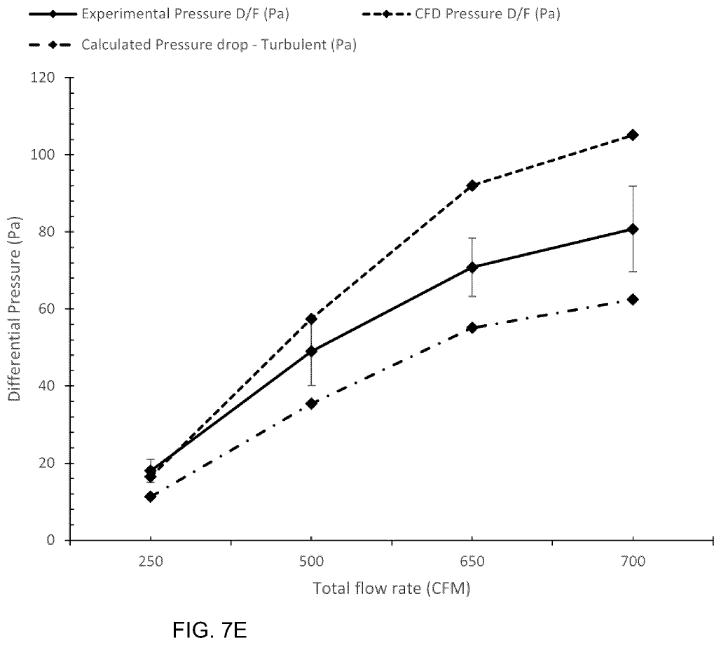

Important performance metrics of the dehumidifier systems are captured and summarized in FIG. 7A. As the humidity ratio is increased, the difference (D/F) between the inlet and outlet increases along with an increase in IEF. This shows that the performance of the system improves considerably at higher humidity ratios which can be achieved at greater inlet temperatures.

The plots in FIG. 7B show how the dehumidification performance increases with an increase in humidity ratio at a constant temperature of 20 °C. At an inlet humidity ratio of 53 GPP the IEF is 0.3 L/kWh and at an inlet humidity ratio of 98 GPP the IEF is 0.7 L/kWh. This results in a 133% increase in IEF from the baseline to a higher moisture content.

As FIG. 7B shows, by increasing the humidity ratio at a fixed temperature, the IEF of the system can be improved. The plots in FIG. 7C show the increase in dehumidification performance by increasing temperature. At an inlet humidity ratio of 76 GPP the IEF is 0.5 L/kWh and at an inlet humidity ratio of 285 GPP the IEF is 1.9 L/kWh. This results in a 280% increase in IEF from 20 °C to 43 °C.

The dehumidifier system was designed to operate at a rated flow rate of 250 CFM. However, the test chamber was capable of pushing flow rates up to 650 CFM. The plots in FIG. 7D show that as the flow rate increases the D/F in humidity ratio between the inlet and outlet decreases but the IEF increases as more air is being processed by the cartridge modules. Between 250 and 650 CFM, the humidity ratio D/F decreases from 56 GPP to 32 GPP which is a 43% decrease in moisture removal. Considering the same flow rates, the IEF increases from 0.91 to 1.29 L/kWh which is a 42% improvement over the rated flow rate.

The plots in FIG. 7E show how the differential pressure across the cartridge module increases with an increase in flow rate. The experimental pressure D/F shows the measured pressure across each cartridge module and compares the data to calculated values and computational fluid dynamics (CFD) predictions. The experimental pressure D/F is 18 Pa at a flow rate of 250 CFM with the calculated value being 37% lower along with the CFD model predicting 8.4% lower than experimental data. At the highest flow rate of 700 CFM the experimental pressure D/F is 81 Pa with the calculated values being 23% lower and the CFD model predicted at 30% higher than the experimental data. The CFD model tends to overpredict the pressure D/F due to the k-epsilon turbulence model selected and this discrepancy increases with an increase in flow rate as the turbulent kinetic energy of the system increases. However, in most cases the calculated pressure D/F is underpredicted as the module geometry is not taken into consideration which results in an ideal case for flow traveling in the air channel.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A membrane cartridge for a dehumidification apparatus, the membrane cartridge comprising:
a cartridge frame having an interior cavity and having a first face opening and a second face opening in fluid communication with the interior cavity, the cartridge frame further having an edge, the edge comprising one or more edge openings in fluid communication with the interior cavity and the two face openings;
a first insert comprising a first perforated surface aligned with the first face opening, the first perforated surface bounded by a first border adjacent the first face opening;
a second insert comprising a second perforated surface aligned with the second face opening, the second perforated surface bounded by a second border adjacent the second face opening;
a first membrane attached to the cartridge frame over the first insert and the first face opening, the first membrane sealed with respect to the first face opening; and,
a second membrane attached to the cartridge frame over the second insert and the second face opening, the second membrane sealed with respect to the second face opening.

2. The cartridge of claim 1, wherein: the first insert comprises a plurality of pins extending from the first perforated surface into the interior cavity; and, the second insert comprises a plurality of receiving apertures into which the plurality of pins is inserted and secured within.

3. The cartridge of claim 2, wherein the second perforated surface comprises a plurality of posts extending from the second perforated surface into the interior cavity, the plurality of posts comprising the plurality of receiving apertures.

4. The cartridge of claim 3, wherein the second perforated surface comprises another plurality of pins extending into the interior cavity and the first perforated surface comprises another plurality of posts comprising another plurality of receiving apertures into which the other plurality of pins is inserted and secured within.

5. The cartridge of claim 1, wherein:
the frame comprises a first recess surrounding the first face opening, the first border engaged with the first recess; and,
the frame comprises a second recess surrounding the second face opening, the second border engaged with the second recess.

6. The cartridge of claim 5, wherein the frame is unattached to the first border and the second border.

7. The cartridge of claim 1, wherein the first and second membranes are attached and sealed to the frame by an adhesive.

8. The cartridge of claim 1, wherein the edge comprises one or more locating apertures alignable with corresponding one or more indexing pins on a dehumidifier to properly align the cartridge when the cartridge is mounted in the dehumidifier.

9. The cartridge of claim 1, wherein the first membrane, the second membrane or both the first and second membrane comprise graphene oxide.

10. A dehumidification apparatus comprising:
a housing having openings permitting a flow of a gas therethrough;
a membrane cartridge parallel to the flow of gas, the membrane cartridge having an edge adjacent to the housing;
a compressible seal between the edge of the membrane cartridge and the housing; and,
a fastener between the housing and the membrane cartridge, the fastener configured to pull the membrane cartridge toward the housing to compress the seal.

11. The apparatus of claim 10, further comprising a vacuum chamber in fluid communication with the edge of the membrane cartridge, the fastener located within the vacuum chamber.

12. The apparatus of claim 10, wherein the membrane cartridge is one of a plurality of membrane cartridges and the housing comprises a plurality of indexing pins to help situate the membrane cartridges parallel to each other in a stack of cartridges in the apparatus.

13. The apparatus of claim 10, wherein the membrane cartridge is the membrane cartridge as defined in any one of claims 1 to 10, and the edge of the membrane cartridge is the edge of the cartridge frame comprising the one or more edge openings.

14. A dehumidifier system comprising the apparatus of claim 10.

15. A dehumidifier system comprising the apparatus of claim 11.

16. A dehumidifier system comprising the apparatus of claim 12.

17. A dehumidifier system comprising the apparatus of claim 13.
